(19) United States
(12) Patent Application Publication
(10) Pub. No.: US 2009/0003194 A1
(43) Pub. Date: Jan. 1, 2009

(54) Resilience Solution for Top Tier Bandwidth Managers

(76) Inventors: Olov Schelen, Norrfjarden (SE); Ulf Bodin, Sunderbyn (SE); Joachim Johansson, Lulea (SE); Joakim Norrgard, Lulea (SE)

Correspondence Address: HARNESS, DICKEY & PIERCE, P.L.C., P.O. BOX 8910, RESTON, VA, 20195, US

(21) Appl. No.: 11/664,794

(22) PCT Filed: Sep. 22, 2005
(86) PCT No.: PCT/SE05/01396

§ 371 Date: Apr. 6, 2007

Related U.S. Application Data
(60) Provisional application No. 60/671,083, filed on Apr. 14, 2005.

(51) Int. Cl. G06F 11/00

(52) U.S. Cl. 370/218

(57) ABSTRACT

The present invention relates to a back up top tier bandwidth manager (160) adapted to back up a top tier bandwidth manager (120) upon fail-over of the top tier bandwidth manager (120) in an Internet Protocol, IP, network. Said IP network comprises the top tier bandwidth manager (120) comprising a resource map (130) and adapted to pre-allocate resources in bulk from a bottom tier of said IP network (150) via a bottom-tier bandwidth manager (140) also located in said IP network. The back up top tier bandwidth manager comprises further a copy of the resource map (130) of the top tier bandwidth manager (120) which it is backing up and means for synchronising states with the bottom tier bandwidth manager upon fail-over of the top tier bandwidth manager.

### FIELD OF THE INVENTION

The present invention relates to arrangements for bandwidth management in an IP network. In particular, it relates to a resilience solution for top tier bandwidth managers, e.g. access bandwidth managers, in said IP network.

### BACKGROUND

A current networking trend is to provide ‘IP all the way’ to wired and wireless units. Some current objectives are to simplify the infrastructure, to support a wide range of applications, and to support diverse user demands on the communication service. To allow this, there is a need for scalable solutions supporting service differentiation and dynamic bandwidth management within IP networks.

The primary goal when the Internet Protocols were designed was to provide an effective technique for interconnecting existing networks. Other important goals were survivability in the face of failure and generality in supporting various services and applications. To reach these goals, the IP protocol suite was designed to provide a connectionless datagram network that does not require signalling and per-flow forwarding state in network elements. It has turned out that the architecture scales to large networks and supports applications making many end-to-end connections (e.g. the World Wide Web).

Traditionally, demanding real-time applications have been built on networks that are vertically optimised for the particular application. This design principle results in networks that are efficient for their purpose, but do not easily support new applications and are in many cases incapable of efficiently multiplexing applications with varying resource demands. It has turned out that the cost of rung several different networks in parallel is high.

IP was from the beginning designed to be a general communication solution. IP technology is now recognised to be cheap and appropriate for supporting both traditional data applications and delay-sensitive real-time applications. To provide expected service for real-time applications, logically (and physically) separate IP networks are used. Each IP network serves only a subset of sensitive applications (e.g. IP telephony) with quite predictable bandwidth requirements. By limiting the range of applications, the total bandwidth demand can be predicted; so that the network can be dimensioned using the same traffic models as are used for vertically optimised networks. The benefit of cheap IP equipment is obtained without requiring support for dynamic service provisioning in the IP technology.

Network operators now aim at cutting the overhead cost of maintaining several parallel networks. One current trend is to simplify the infrastructure by running all kinds of applications, with various network service demands, in the same logical IP network (i.e. the Internet). This means that the application heterogeneity in IP networks is increasing.

In the research and standardisation bodies the development of QoS support has progressed from providing signalled solutions for the Internet (somewhat resembling the solutions used in vertical networks) to now recognising that more stateless solutions are favourable.

The scalability problems of solutions using per-flow QoS management in routers have resulted in a new approach being taken in the IETF, known as the differentiated services architecture. The objective is to provide scalable QoS support by avoiding per-flow state in routers. The basic idea is that IP packet headers include a small label (known as the diffserv field) that identifies the treatment (per-hop behaviour) that packets should be given by the routers. Consequently, core routers are configured with a few forwarding classes and the labels are used to map packets into these classes. The architecture relies on packet markers and policing functions at the boundaries of the network to ensure that the intended services are provided.

One advantage of differentiated services is that the model preserves the favourable properties that made the Internet successful; it supports scalable and stateless forwarding over interconnected physical networks of various kinds. The standard model is, however, limited to differentiated forwarding in routers and therefore the challenge lies in providing predictable services to end users.

Qualitative services (relatively better than best-effort services, but depending on where the traffic is sent and on the load incurred by others at the time) can be provided by relying only on diffserv support in routers and bandwidth management mechanisms for semi-static admission control and service provisioning.

To provide quantitative (minimum expectation) service, resources must be dynamically administrated by the bandwidth management mechanisms and involve dynamic admission control to make sure that there are sufficient resources in the network to provide the services committed.

The entity performing dynamic admission control is here called a bandwidth manager. This entity keeps track of the available resources by managing a resource map and performs admission control on incoming requests for bandwidths from clients. To perform the admission control the bandwidth manager also stores a history of previously admitted bandwidth reservations. The bandwidth manager takes decisions to admit new requests for bandwidth based on the total amount of available resources, the amount currently reserved by previously reservations and the amount of bandwidth requested. In this specification, it is assumed that the bandwidth managers perform admission control and once a request is admitted, the bandwidth manager is then no longer involved in that request.

The mechanisms should provide accurate bandwidth control both in a top tier and a bottom tier of the network. An example of a top tier is an access network and an example of a bottom tier is a core network. Thus, a bandwidth manager in the top tier is referred to as a top tier bandwidth manager and a bandwidth manager in the bottom tier is referred to as a bottom tier manager. Moreover, a bandwidth manager in the access network is in this application referred to as an access bandwidth manager and a bandwidth manager in the core network is referred to as a core bandwidth manager.

To handle a very high rate of call admission requests, which may come from services such as IP-telephony, a two-tier architecture is required with top tier bandwidth managers in the top tier and bottom tier bandwidth managers in the bottom tier.

In order to maintain service availability in disaster scenarios where a complete server site may become unavailable a geographical fail-over solution is needed. Since it may not be feasible to continuously synchronize all state to a distant standby bandwidth manager a solution is needed where the number of states to be synchronized is minimized.

### SUMMARY OF THE INVENTION

Thus, an object with the present invention is to minimize service interruption during a bandwidth manager fail-over by allowing continuous service availability while the call state is synchronizing.

The object above is achieved by the back up top tier bandwidth manager defined by the characterising part of claim 1 and by the network defined by the characterising part of claim 12.

Preferred embodiments are defined by the dependent claims.

Thus the back up top tier bandwidth manager according to the present invention comprising a copy of the resource map of the top tier bandwidth manager which it is backing up and means for synchronising states with the bottom tier bandwidth manager upon fail-over of the top tier bandwidth manager, makes it possible to minimize service interruption during a bandwidth manager fail-over by allowing continuous service availability while the call state is synchronizing.

Thus the network according to the present invention comprising a copy of the resource map of the top tier bandwidth manager which it is backing up and means for synchronising states with the bottom tier bandwidth manager upon fail-over of the top tier bandwidth manager, makes it possible to minimize service interruption during a bandwidth manager fail-over by allowing continuous service availability while the call state is synchronizing.

According to one embodiment, the back up top tier bandwidth manager comprises means for performing fail-over from a failed top tier bandwidth manager by IP address takeover, wherein the backup top tier bandwidth manager comprises means for taking over the IP address of said failed top tier bandwidth manager as the routing protocol in use announce the new route to this IP address

According to one embodiment, the back up top tier bandwidth manager comprises means for performing fail-over from a failed top tier bandwidth manager by configuring the clients with a primary and a secondary address.

According to one embodiment, one of the states to be synchronised is the already admitted and active calls call.

According to one embodiment, one of the states to be synchronised is the pre-allocated resources in bulk.

According to one embodiment, the back up top tier bandwidth manager comprises a separate connection or a buffer to a client wherein the separate connection or the buffer is adapted to transfer call state synchronisation in parallel with normal operation.

According to one embodiment, the back up top tier bandwidth manager comprises means for handling new calls immediately while already admitted calls are refreshed at a slower timescale.

According to one embodiment, the back up top tier bandwidth manager comprises means for completing full synchronization before dealing with new call attempts.

According to one embodiment, the back up top tier bandwidth manager comprises means for skipping synchronization.

According to one embodiment, the back up top tier bandwidth manager comprises means for refreshing active calls periodically.

According to one embodiment, the top tier is the access layer and that the top tier bandwidth manager is an access bandwidth manager and that the back up top tier bandwidth manager is a back up access bandwidth manager.

According to one embodiment, the bottom tier is the core network and that the bottom tier bandwidth manager is a core bandwidth manager.

An advantage with the present invention is that no continuous replication of state between the resilient access bandwidth managers according to the present invention is needed since the resource state is synchronized with the core bandwidth manager and the call state is migrated by serving new requests (calls) while the calls that were active will time out.

A further advantage is that the signalling to the core bandwidth manager is minimized by using aggregated bulk reservations and thus avoiding per call synchronisation with the core bandwidth manager.

A yet further advantage of the present invention is that the synchronization of the resources through the core is fast since the reservations are aggregated into a few bulk reservations. This allows fast recovery of the resource map and continuous service availability.

### BRIEF DESCRIPTION OF THE DRAWINGS

FIG. 1a illustrates a network wherein the present invention may be implemented.

FIG. 1b illustrates the normal operation with an active access bandwidth manager for call admission control according to the present invention.

FIG. 2 illustrates the operation during fail-over to the standby access bandwidth manager according to the present invention.

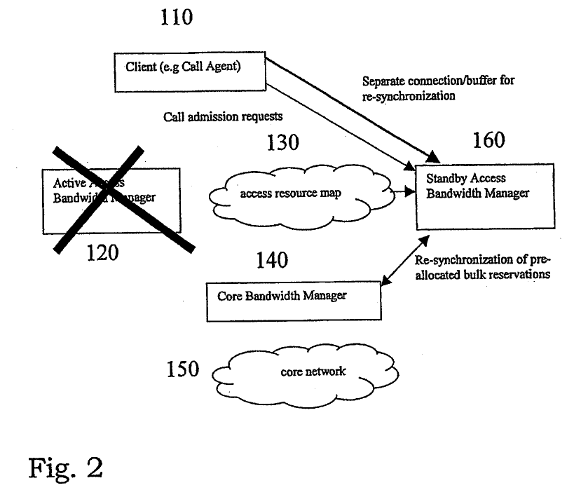

FIG. 3 illustrates the transition from an old access bandwidth manager to a new access backup bandwidth manager.

### DETAILED DESCRIPTION OF THE INVENTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

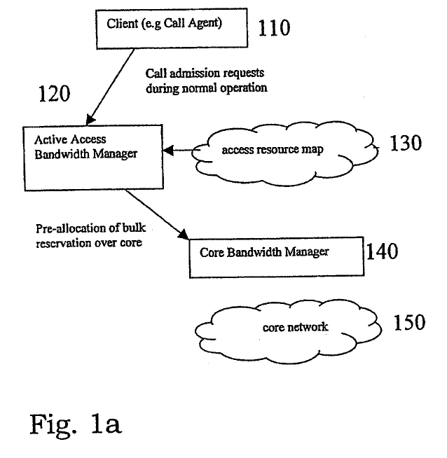

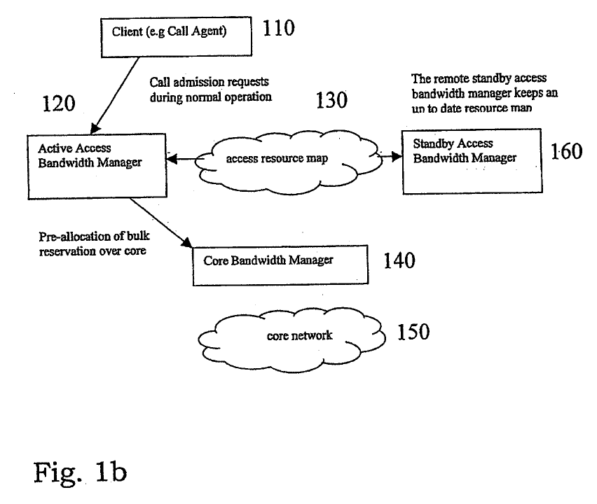

The back up bandwidth manager according to the present invention is preferably implemented in a network shown in FIG. 1a. FIG. 1a illustrates an active top tier bandwidth manager 120 in the top tier handling requests received from the client 110 (e.g. from call agents) for calls from one subscriber to another. It should be noted that the top tier in this FIGS. 1a-1b is exemplified by an access network and the bottom tier by a core network. Since end-to-end bandwidth management required for guaranteeing QoS the access bandwidth managers involved will also verify that there are enough resources across the core network 150 by requesting the core bandwidth managers 140 for bandwidth across the core network. These requests over the core network are preferably done by pre-allocating bulk bandwidth reservations between the different access networks.

The core bandwidth manager 140 need not be involved in processing bandwidth requests for individual calls since access bandwidth managers 120 can make local decisions on core bandwidth based on pre-allocation of bulk reservations across the core 150. Thus, access bandwidth managers 120 deal with high-rate/short-holding-time reservations while the core bandwidth manager 140 deals with low-rate/long-holding-time bulk reservations.

Notice that the concept of two-tier architecture can be applied in many different levels and locations and the solution according to the present invention is applicable in such configurations also. A two-tier architecture can for example be applied within an access network for access network scalability reasons when the bottom tier within the access is represented by an access bandwidth manager that keeps the access network resource map while the top tier of access bandwidth managers receives the call admission requests and pre-allocates resources with the bottom-tier access bandwidth manager that in turn pre-allocates resources with the core bandwidth manager. In this case the solution according to the present invention applies to at least the access bandwidth-managers. In very large access topologies even the top tier access bandwidth managers may keep the resource map for parts of the access network.

The object of the present invention is achieved by providing a geographical bandwidth manager resilience that is based on that each top tier bandwidth manager, typically access bandwidth manager, has one or more backups, denoted back up to tier bandwidth manager, located in other locations. The backup top tier bandwidth manager is illustrated as a back up access bandwidth manager in FIG. 1b. FIG. 1b is identical to FIG. 1a, except for the added backup top tier bandwidth manager 160. The backup top tier bandwidth manager 160 maintains a copy of the network resource map (capacity allocation map) 130 of the bandwidth manager 120 it is backing up and comprises means for synchronising states with a bottom tier bandwidth manager. It should be noted that the backup top tier bandwidth manager is not updated on the current state of accepted bandwidth reservations or pre-allocations across the bottom tier of the network, typically the core network. Both active 120 and backup top tier bandwidth managers 160 are continuously updated on changes in the resource map 130, which contains information on the current topology and amount of resources provisioned (i.e., layer2, routing and MPLS). Fail-over from an active to a backup top tier bandwidth manager is either performed by IP takeover, where the IP address of an unreachable bandwidth manager is taken over by its backup as the routing protocol in use announce the new route to this IP address or by configuring the clients with a primary and secondary address.

In case of a fail-over from an active top tier bandwidth manager to a back-up top tier bandwidth manager, a huge number of states have to be synchronised for a full synchronisation of state between the bandwidth managers. Assuming that a top tier bandwidth manager, e.g. an access bandwidth manager, can handle a call rate of up to 1000 calls/second an average call duration of 120 seconds gives up to 120 000 active calls. This amount of data is almost impossible to synchronize if the fail-over time must be short and the service is on hold until the synchronization is complete.

Thus, the object of the present invention is further achieved by providing resilience of top tier bandwidth managers that is implemented by minimising the amount of states that needs to be transferred upon a geographical fail-over. This minimising is accomplished thanks to that bulk bandwidth is automatically pre-allocated from the bottom tier of the network, e.g. the core network, by means of synchronization (auditing) between the top tier and the bottom tier bandwidth managers and that flexible re-synchronisation of already admitted calls is allowed i.e. the re-synchronisation of resources with other bandwidth managers are synchronised by using the pre-allocation of bulk resources from the core network. Synchronisation (auditing) between bandwidth managers can be performed either by:
Pull: the top tier bandwidth manager (e.g. access bandwidth manager) requesting the resource allocation state from the bottom tier manager (e.g. the core bandwidth manager)
Push: the bottom tier bandwidth manager sends the resource allocation state upon failover.
Re-allocation: the resource allocation state in the bottom tier bandwidth manager is reset and re-allocated by the top tier bandwidth manager.

The pre-allocation of bandwidth provides continuous per-call end-to-end service availability in the top tier bandwidth managers even during temporary outage of the bottom tier bandwidth manager. Pre-allocation of bulk bandwidth also lowers the signalling on the bottom tier bandwidth managers.

Thus, the present invention enables fast fail-over from one top tier bandwidth manager to a backup top tier bandwidth manager by minimizing the state that has to be synchronised before the service is available on the backup top tier bandwidth manager as stated above. Since the backup top tier bandwidth manager is updated with the network resource map there are mainly two sources of state that need to be synchronized:
The pre-allocated resources across the bottom tier of the network (e.g. the core network and thus the core resource state) and
the already admitted and active calls (call state).

Since the pre-allocated resources across the bottom tier are bulk reservations the number of reservations to synchronize with the bottom tier bandwidth manager is minimized. The number of active calls can however be substantial amount of state that needs to be synchronised.

According to a preferred embodiment of the present invention, the call state synchronisation is made optional by introducing a separate connection or a buffer between the client (e.g. call agent) and the backup top tier bandwidth manager where the client can send call state synchronisation in parallel with normal operation.

This preferred embodiment makes it possible to ensure synchronization for long-lived calls, while a large number of short calls may terminate before re-synchronization is complete.

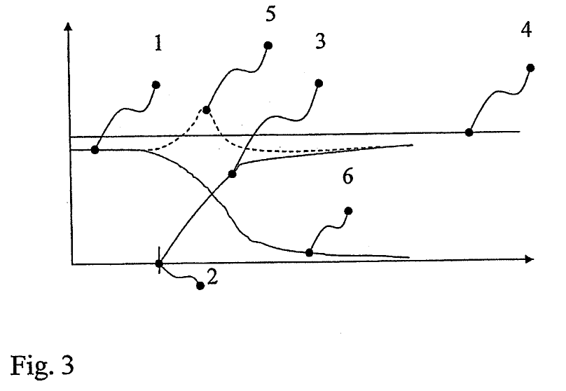

This strategy relies on a relatively low block-rate so that the risk of over subscription of the service, i.e. admitting more calls than what is provisioned for the service, is low and that some unfairness, as to pre-empting admitted calls before new calls in some cases, are acceptable. For a voice service with relatively short average call duration the old call state will time out and the new state (from new calls) will build up within a relatively short time frame. During this transition there is a risk of over-subscription of the service since after the fail-over it will take some time for the new top tier bandwidth manager to build up the state of active calls and those calls still active that has not been re-synchronized will not be accounted. During this period the new backup bandwidth manager may admit more calls than it should, simply because there are some active calls it does not know yet. However, this risk can be reduced by using smart re-synchronisation. The transition from an old top tier bandwidth manager to a new top tier backup bandwidth manager is illustrated in FIG. 3, wherein
1. denotes the old call state. This is the amount of reserved resources at one point in the resource map.
2. denotes the time of a failover. At this point the failover begins and the old call state will begin to time out while the new call state (3) starts building UP.
3. denotes the new call state. This is the new call state that is building up in the back-up top tier bandwidth manager.
4. denotes the available resources for the current service. This is either local resources provisioned in the resource map of the top tier bandwidth manager or acquired resources pre-allocated in the bottom tier bandwidth manager, which is synchronized with the bottom tier bandwidth manager directly after the failover.
5. denotes the potential over-subscription. During a short period of the call-state migration the new top tier bandwidth manager may admit more calls than what is provisioned according to (4).
6. denotes long term calls. These may need to be synchronized from the clients to be migrated to speed up the complete recovery of the call state.

By using the separate resubmission connection (or buffer management) according to the preferred embodiment, the clients/call agents are allowed to implement different fail-over strategies depending on the requirements. Examples of such strategies are:
Complete full synchronization before dealing with new call attempts, however high priority calls are always dealt with first. To achieve short fail-over times by using this strategy requires more computing power relative to the others while it implements the best fairness to already admitted calls.
Deal with synchronization in parallel with new call attempts. In this way, new call attempts will be dealt with directly while already admitted calls are refreshed at a slower timescale which implies that they run an increased risk of being pre-empted before a new call. That depends on that the new bandwidth manager is not aware of an already admitted call before a refresh of the already admitted call is performed, which results in that the bandwidth manager may admit too many new calls. Thus the already admitted call may be preempted once the refresh of that already admitted call is performed unless overbooking is accepted. Since re-synchronization after fail-over is the performance bottleneck of the top tier bandwidth manager, the ability of call agents to refresh reservations for active calls according to this example provides minimum response-time for new calls during fail-over.
Skip synchronization. This strategy allows call agents to deal with new calls directly. The assumption is that a majority of the already admitted calls will time-out within a reasonably short timeframe. New call state will build up from new calls only. During the transition period there is increased risk of over-subscription of bandwidth as mentioned above. This risk depends on the call blocking rate at the time of fail-over.

According to a further preferred embodiment of the present invention, a refresh scheme is introduced where active calls are refreshed periodically in order to reduce the peak load during resynchronisation (i.e. refreshing). In this way the load will be spread over a longer time-frame and short/soon-to-time-out calls will be excluded automatically from the re-synchronization.

Thus the present invention relates to a back up top tier bandwidth manager and an IP network. I.e., the back up top tier bandwidth manager according to the present invention is adapted to back up a top tier bandwidth manager upon fail-over of the top tier bandwidth manager in an IP network, wherein said IP network comprises the top tier bandwidth manager comprising a resource map and that is adapted to pre-allocate resources in bulk from a bottom tier of said IP network via a bottom-tier bandwidth manager also located in said IP network. As stated above a bandwidth manager is an entity that is adapted to perform admission control.

The bandwidth manager may be implemented by a computer program product. Such a computer program product may be directly loadable into a processing means in a computer, comprising the software code means for performing a copy of the resource map of the top tier bandwidth manager which the back up top tier bandwidth manager is backing up and software code means for synchronising states with the bottom tier bandwidth manager upon fail-over of the top tier bandwidth manager.

The computer program product may be stored on a computer usable medium, comprising readable program for causing a processing means in a node B, to control the execution of the steps of performing a copy of the resource map of the top tier bandwidth manager which the back up top tier bandwidth manager is backing up and software code means for synchronising states with the bottom tier bandwidth manager upon fail-over of the top tier bandwidth manager.

The present invention also addresses an IP network wherein the back up top tier bandwidth manager is adapted to operate. The IP network comprises a top tier bandwidth manager comprising a resource map and being adapted to pre-allocate resources in bulk from a bottom tier of said IP network via a bottom-tier bandwidth manager also located in said IP network, the IP network comprises further a back up top tier bandwidth manager adapted to back up the top tier bandwidth manager upon fail-over of the top tier bandwidth manager.

The present invention is not limited to the above-described preferred embodiments. Various alternatives, modifications and equivalents may be used. Therefore, the above embodiments should not be taken as limiting the scope of the invention, which is defined by the appending claims.

1. A back up top tier bandwidth manager adapted to back up a top tier bandwidth manager upon fail-over of the top tier bandwidth manager in an Internet Protocol, IP, network, wherein said IP network comprises the top tier bandwidth manager comprising a resource map and being adapted to pre-allocate resources in bulk from a bottom tier of said IP network via a bottom-tier bandwidth manager also located in said IP network, the back up top tier bandwidth manager is wherein it comprises a copy of the resource map of the top tier bandwidth manager which it is backing up and means for synchronising states with the bottom tier bandwidth manager upon fail-over of the top tier bandwidth manager.

2. The back up top tier bandwidth manager according to claim 1, wherein it comprises means for performing fail-over from a failed top tier bandwidth manager by IP address takeover, wherein the backup top tier bandwidth manager comprises means for taking over the IP address of said failed top tier bandwidth manager as the routing protocol in use announce the new route to this IP address

3. The back up top tier bandwidth manager according to claim 1, wherein it comprises means for performing fail-over from a failed top tier bandwidth manager by configuring the clients with a primary and a secondary address.

4. The back up top tier bandwidth manager according to claim 1, wherein one of the states to be synchronised is the already admitted and active calls call.

5. The back up top tier bandwidth manager according to claim 1, wherein one of states is the pre-allocated bulk resources.

6. The back up top tier bandwidth manager according to claim 1, wherein it comprises a separate connection or a buffer to a client wherein the separate connection or the buffer is adapted to transfer call state synchronisation in parallel with normal operation.

7. The back up top tier bandwidth manager according to claim 6, characterised by means for handling new calls immediately while already admitted calls are refreshed at a slower timescale.

8. The back up top tier bandwidth manager according to claim 6, wherein for completing full synchronization before dealing with new call attempts.

9. The back up top tier bandwidth manager according to claim 6, wherein for skipping synchronization.

10. The back up top tier bandwidth manager according to claim 6, wherein for re-freshing active calls periodically.

11. The back up top tier bandwidth manager according to claim 1, wherein the top tier is the access layer and that the top tier bandwidth manager is an access bandwidth manager and that the back up top tier bandwidth manager is a back up access bandwidth manager.

12. The back up top tier bandwidth manager according to claim 1, wherein the bottom tier is the core network and that the bottom tier bandwidth manager is a core bandwidth manager.

13. An Internet Protocol, IP, network comprising a top tier bandwidth manager comprising a resource map and being adapted to pre-allocate resources in bulk from a bottom tier of said IP network via a bottom-tier bandwidth manager also located in said IP network, the IP network comprises further a back up top tier bandwidth manager adapted to back up the top tier bandwidth manager upon fail-over of the top tier bandwidth manager, the network is wherein the back up top tier bandwidth manager comprises a copy of the resource map of the top tier bandwidth manager which it is backing up and means for synchronising states with the bottom tier bandwidth manager upon fail-over of the top tier bandwidth manager.

14. The network according to claim 13, wherein it comprises means for performing fail-over from a failed top tier bandwidth manager by IP address takeover, wherein the backup top tier bandwidth manager comprises means for taking over the IP address of said failed top tier bandwidth manager as the routing protocol in use announce the new route to this IP address

15. The network according to claim 13, wherein it comprises means for performing fail-over from a failed top tier bandwidth manager by configuring the clients with a primary and a secondary address.

16. The network according to claim 13, wherein one of the states to be synchronised is the already admitted and active calls call.

17. The network according to claim 13, wherein that one of the states to be synchronised is the pre-allocated bulk resources.

18. The network according to claim 13, wherein the back up top tier bandwidth manager comprises a separate connection or a buffer to a client wherein the separate connection or the buffer is adapted to transfer call state synchronisation in parallel with normal operation.

19. The network according to claim 18, wherein for handling new calls immediately while already admitted calls are refreshed at a slower timescale.

20. The network according to claim 19, wherein for completing full synchronization before dealing with new call attempts.

21. The network according to claim 19, wherein for skipping synchronization.

22. The network according to claim 19, wherein for re-freshing active calls periodically.

23. The network according to claim 13, wherein the top tier is the access layer and that the top tier bandwidth manager is an access bandwidth manager and that the back up top tier bandwidth manager is a back up access bandwidth manager.

24. The network according to claim 12, wherein the bottom tier is the core network and that the bottom tier bandwidth manager is a core bandwidth manager.
